(19) United States
(12) Patent Application Publication
(10) Pub. No.: US 2013/0038484 A1
(43) Pub. Date: Feb. 14, 2013

(54) OBSTACLE DETECTION DEVICE

(71) Applicants: Makoto Ohkado, Nisshin-shi Aichi-ken (JP); Masaru Ogawa, Seto-shi Aichi-ken (JP); Setsuo Tokoro, Miyoshi-shi Aichi-ken (JP); Koji Suzuki, Susono-shi Shizuoka-ken (JP)

(72) Inventors: Makoto Ohkado, Nisshin-shi Aichi-ken (JP); Masaru Ogawa, Seto-shi Aichi-ken (JP); Setsuo Tokoro, Miyoshi-shi Aichi-ken (JP); Koji Suzuki, Susono-shi Shizuoka-ken (JP)

(73) Assignee: TOYOTA JIDOSHA KABUSHIKI KAISHA, Toyota-shi Aichi-ken (JP)

(21) Appl. No.: 13/514,304

(22) PCT Filed: Dec. 8, 2010
(86) PCT No.: PCT/IB10/03138

§ 371 Date: Jun. 7, 2012

(30) Foreign Application Priority Data
Dec. 9, 2009 (JP) 2009-279335

(51) Int. Cl. G01S 13/93

(52) U.S. Cl. 342/70

(57) ABSTRACT

An obstacle detection device includes; a primary device that determines the presence or absence of the target object on the basis of a comparison between the transmitted wave and the reception wave; a storage device that, when it is determined that the object is present, acquires a reception power of the reception wave at a control period determined beforehand, and stores the reception power as reception power time series data; a secondary device that determines whether a value relating to a time series change pattern of the data falls within a predetermined range set beforehand on the basis of phase interference, of the reception wave, that depends on a height of the object from a road; and a output device that determines the object to be an obstacle and outputs a result of this determination, when it is determined that the value relating to the pattern falls within the range.

### BACKGROUND OF THE INVENTION

1. Field of the Invention

The invention relates to an obstacle detection device, and more particularly to an obstacle detection device that detects an obstacle by transmitting waves and receiving reflected waves from a target object.

2. Description of the Related Art

Frequency-modulated continuous-wave radars (FM-CW radars) or the like are used for detecting whether an obstacle is present on the travel path of a traveling vehicle. The obstacle may be another traveling vehicle, and hence obstacle detection includes also a function of detecting, for instance, distance between vehicles. Although the distance to an obstacle and the relative speed with respect to the obstacle can be measured by using an FM-CW radar, the FM-CW radar uses waves, which gives rise to several problems. One problem is the chance of detection, as an obstacle, of an object located above the traveling range of the vehicle. Another problem is the chance of detection of a plate or puddle, which are objects on the road surface that do not impede the travel of the vehicle.

For instance, Japanese Patent Application Publication No. 2006-98220 (JP-A-2006-98220) discloses a preceding vehicle detection device being an obstacle detection device that does not determine road-surface reflective plates, or overhead structures above the road surface, to be obstacles, wherein irradiation waves are irradiated in such a manner that upper irradiation waves and lower irradiation waves partially overlap each other, such that the type of the object at which irradiation waves are reflected is decided on the basis of reflected wave intensity from the upper irradiation waves and the lower irradiation waves.

Japanese Patent Application Publication No. 2003-252147 (JP-A-2003-252147) discloses an obstacle detection device for vehicles that discriminates between an actual obstacle and a virtual image (mirror image) of a puddle on the road, wherein a displacement amount of a target object per unit time is calculated by image processing and radar ranging, on the basis of the distance to the target object by image processing and the distance to the target object by radar ranging, such that the target object is determined not to be an obstacle when the two calculated displacement amounts do not match.

Japanese Patent Application Publication No. 2004-239744 (JP-A-2004-239744) discloses a radar device that can distinguish ghost data from road surface reflection or the like, wherein the size of an object to be measured is calculated on the basis of information on, for instance, distance and received power intensity sensed by radar; a radar cross section (RCS) threshold value is set beforehand for a radar cross section (RCS), as a threshold value of the size of the object to be measured that is detected by radar, in accordance with the bearing angle of the object to be measured, within a radar detection range, so that a detected object is determined to be an unwanted object when at or below the RCS threshold value.

The above related technologies propose schemes for ruling out the chance of detecting, as an obstacle, something that is not actually an obstacle. The method of JP-A-2006-98220 allows detecting on-road obstacles and in-air obstacles, but requires to that end some kind of movable illumination, as well as imaging element. The method of JP-A-2003-252147 allows distinguishing between actual obstacles and virtual images (mirror images) of puddles or the like, but treats, as obstacles, on-road unwanted objects, such as on-road iron plates, that are not virtual images (mirror images). The method requires, also imaging elements and image processing. The method according to JP-A-2004-239744 allows differentiating, on the basis of RCS, between ghost data and original vehicle peaks, but fails to distinguish obstacles having an RCS similar to that of vehicles, for instance in iron plates or the like having good reflectance.

In the above technologies, objects that are not obstacles are considered as obstacles in methods that rely on waves, fix instance radar waves, for detecting obstacles. At present, other detection methods are used concomitantly in order to avoid the above occurrence, as disclosed in JP-A-2006-98220 and JP-A-2003-252147.

### SUMMARY OF THE INVENTION

The invention provides an obstacle detection device that allows appropriately detecting an obstacle, relying on only a method that uses waves.

The invention is based an the finding that although an FM-CW radar used in related art allows obtaining the speed and position of a target object, a study of time series data of received power reveals that phase interference of waves (reception waves) gives rise to peaks, and that the features of the peaks depend on the height of the target object from the road. The device below is an embodiment of this finding.

Specifically, an aspect of the invention relates to an obstacle detection device. The obstacle detection device has a primary, determination device that transmits a wave, receives a reception wave from a target object, and determines the presence or absence of the target object on the basis of a comparison between the transmitted wave and the reception wave; a storage device that, when the primary determination device determines that the target object is present, acquires a reception power of the reception wave at a control period determined beforehand, and stores the acquired reception power as reception power time series data in time series; a secondary determination device that determines whether a value relating to a time series change pattern of the reception power time series data falls within a predetermined range set beforehand on the basis of phase interference, of the reception wave, that depends on a height of the target object from a road; and a detection output device that determines the target object to be an obstacle and outputs a result of this determination, when the secondary determination device determines that the value relating to the time series change pattern falls within the predetermined range.

In the above configuration, the obstacle detection device has a primary determination device that transmits a wave, receives a reception wave from a target object, and determines the presence or absence of the target object on the basis of a comparison between the transmitted wave and the reception wave, and has also a secondary determination device that, when the primary determination device determines that the target object is present, acquires a reception power of the reception wave at a control period determined beforehand, and stores the acquired reception power as reception power time series data in time series, determines whether or not a value relating to a time series change pattern of the reception power time series data falls within a predetermined range set beforehand on the basis of phase interference, of the reception wave, that depends on a height of the target object from a road. Also, when the secondary determination device determines that the value relating to the time series change pattern falls within the predetermined range, it is determined that the target object is an obstacle and the result of this determination is outputted.

Therefore, it becomes possible to appropriately distinguish and detect obstacles that cannot be distinguished by the primary determination device, by signal processing and relying only on a method that uses waves, for instance by setting a predetermined range of the height of the target object from the road in terms of whether the target object is an obstacle or not.

In the above obstacle detection device, the secondary determination device may use a period of the time series change pattern as the value relating to the time series change pattern, and determine whether the period falls within the predetermined range.

In the obstacle detection device, the secondary determination device may use, as the value relating to the time series change pattern, at least one of the number of minimum points, the number of maximum points, the number of decrease-side inflection points and the number of increase-side inflection points of the reception power within a predetermined determination span that is set beforehand in the reception power time series data, and determine whether a sum of at least one of the number of the minimum points, the number of the maximum points, the number of the decrease-side inflection points and the number of the increase-side inflection points falls within the predetermined range.

The secondary determination device of the obstacle detection device uses at least one of the number of minimum points, the number of maximum points, the number of decrease-side inflection points and the number of increase-side inflection points of the reception power within a predetermined determination span that is set beforehand in the reception power time series data, and determines whether a sum of at least one of the number of the minimum points, the number of the maximum points, the number of the decrease-side inflection points and the number of the increase-side inflection points falls within the predetermined range. Wave phase interference that depends on the height of the target object from the road becomes manifest as changes in the spacing between those points of reception power. Obstacles can be appropriately distinguished and detected by exploiting this feature.

In the obstacle detection device, the secondary determination device may use, as the value relating to the time series change pattern, the number of the minimum points of the reception power within a predetermined determination span that is set beforehand in the reception power time series data, and may determine whether the number of the minimum paints falls within the predetermined range.

In the obstacle detection device, the secondary determination device may set, as the predetermined range, a range of a sum of at least one of the number of the minimum points, the number of the maximum points, the number of the decrease-side inflection points and the number of the increase-side inflection points corresponding to a range of height of the target object from the road that is set beforehand, on the basis of a relationship, set beforehand, between the height of the target object from the road and at least one of the number of the minimum points, the number of the maximum points, the number of the decrease-side inflection points and the number of the increase-side inflection points, and may determine whether the sum falls within the predetermined range.

The secondary determination device of the obstacle detection device determines whether the sum of at least one of the number of the minimum points, the number of the maximum points, the number of the decrease-side inflection points and the number of the increase-side inflection points falls within the predetermined range on the basis of a relationship, set beforehand, between the height of the target object from the road and at least one of the number of the minimum points, the number of the maximum points, the number of the decrease-side inflection points and the number of the increase-side inflection points. Therefore, it becomes possible to discriminate appropriately between whether the target object is an obstacle or something else, according to the height from the road.

In the obstacle detection device, the secondary determination device may use a maximum reduction width of the time series change pattern as the value relating to the time series change pattern, and determine whether the maximum reduction width falls within the predetermined range.

The secondary determination device of the obstacle detection device uses a maximum reduction width of the time series change pattern and determines whether the maximum reduction width falls within the predetermined range. Wave phase interference that depends on the height of the target object from the road becomes manifest as changes in the maximum reduction width of reception power. Obstacles can be appropriately distinguished and detected by exploiting this feature.

In the obstacle detection device, the primary determination device may determine the presence or absence of the target object using an FM-CW radar.

The primary determination device of the obstacle detection device uses an FM-CW radar. Accordingly, time-proven devices in related art can be used without modification.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a diagram for explaining detection of an obstacle by an obstacle detection device installed in a vehicle, in an embodiment according to the invention;

FIG. 2 is a diagram for explaining the configuration of an obstacle detection device in an embodiment according to the invention;

FIG. 3 is a-diagram for explaining the principle of detection of relative speed and distance to a target object by an FM-CW radar;

FIG. 4 is a diagram for explaining envisaged environment conditions of an obstacle detection device of an embodiment according to the invention;

FIG. 5 is a diagram for explaining a situation wherein a vehicle approaches a stationary target object, in an obstacle detection device of an embodiment according to the invention;

FIG. 6 is a diagram illustrating an example of time series data of received power in an obstacle detection device of an embodiment according to the invention;

FIG. 7 is a diagram for explaining an example a threshold value range in an embodiment according to the invention; and

FIG. 8 is a flowchart illustrating an obstacle detection sequence in an embodiment according to the invention.

### DETAILED DESCRIPTION OF EMBODIMENTS

Embodiments of the invention will be explained in detail below with reference to accompanying drawings. In the explanation below, an FM-CW radar is used as the primary determination device, but, alternatively, a transceiver of wave signals can be used as the primary determination device, such that secondary determination can be performed by processing time series data of power received by the transceiver. For instance, there can be used a continuous wave radar of an arbitrarily set wavelength. A transceiver of continuous pulse signals may also be used as the primary determination device.

The explanation below focuses on an obstacle detection device installed in a vehicle, but the obstacle detection device may be also installed hi moving objects other than vehicles. As the case may require, a fixedly disposed obstacle detection device may be used for detecting moving objects. The numerical values and so forth in the below explanation are given by way of example, and can be appropriately modified in accordance with for instance, the specifications of the obstacle detection device.

In all the drawings, identical constituent elements are denoted with the same reference numerals, and a recurrent explanation thereof will be omitted. In the explanation, already-disclosed reference numerals may also used, as the case may require.

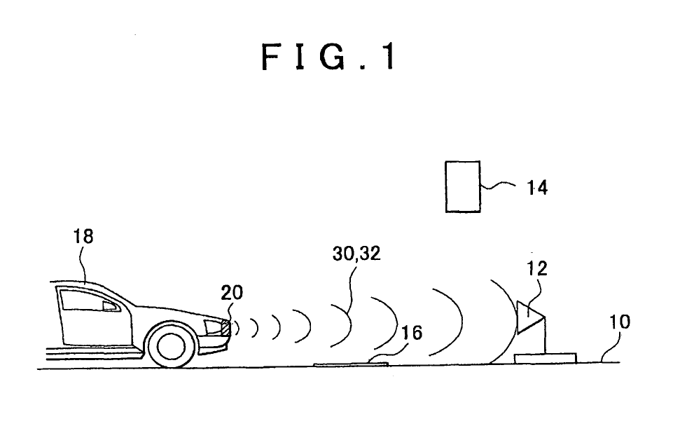

FIG. 1 is a diagram for explaining detection of an obstacle by an obstacle detection device 20 installed in a vehicle. The obstacle detection device 20 is a target object sensing device of FM-CW radar-type installed in the front of a vehicle 18. Herein, the obstacle detection device 20 has the function of, when an obstacle appears as the vehicle 18 is traveling along the road 10, issuing an appropriate output such as an alarm to notify a user of the obstacle.

FIG. 1 illustrates, by way of example, three types of target object that constitute a detection target object of the obstacle detection device 20. In one case, specifically, the target object is an on-road obstacle 12, on a road 10, that impedes the travel of the vehicle 18 by colliding with the latter. Accordingly, the on-road obstacle 12 is an object, having size and a height position such that at least part of a cross section of the vehicle, perpendicular to the travel direction, comes into contact with the on-road obstacle 12. The other two target objects do not impede the travel of the vehicle 18. One of these is an in-air target object 14 sufficiently higher than the topmost height in the vehicle. The other target object is a road-surface target object 16, for instance an iron plate or the like on the road surface.

The obstacle detection device 20 has the functions of transmitting FM-CW millimeter waves, receiving reception waves from a target object, determining the presence or absence of a target object on the basis of a comparison between a transmitted wave 30 and a reception wave 32, determining whether the target object is an on-road obstacle 12, an in-air target object 14, or a road-surface target object 16, and issuing an appropriate output such as an alarm, when the target object is an on-road obstacle 12.

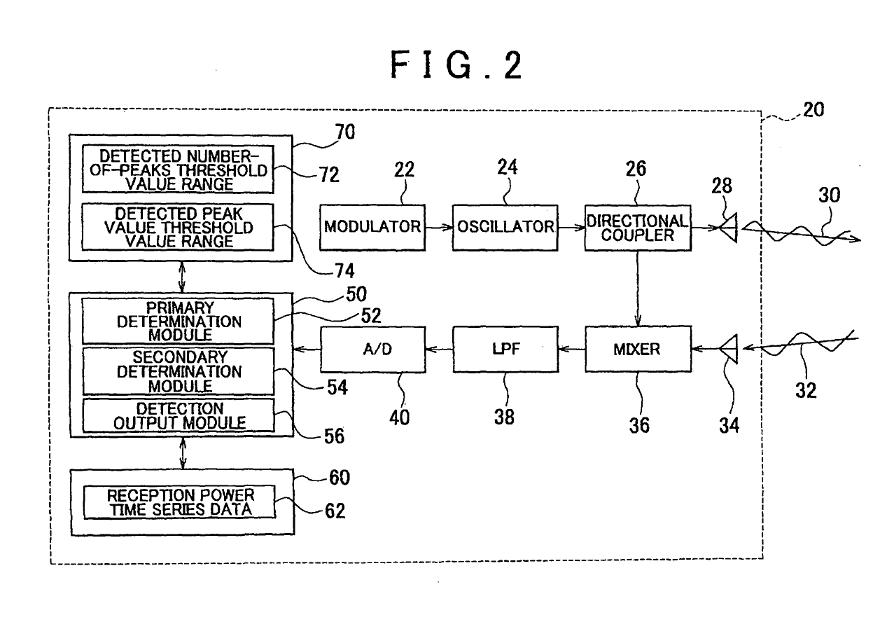

FIG. 2 is a diagram illustrating the configuration of the obstacle detection device 20. The basic configuration of the obstacle detection device 20 is that of an FM-CW radar used for on-board obstacle sensing. This configuration is supplemented with suitable signal processing, so as to allow appropriately detecting the on-road obstacle 12.

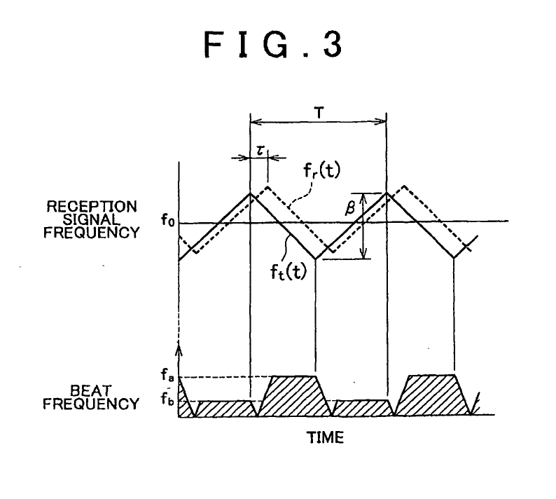

In FIG. 2, a modulator 22 for frequency modulation of continuous waves, an oscillator 24 for generating continuous waves, a directional coupler 26 having a power distribution function whereby the output from the oscillator 24 is divided in two, a transmitting antenna 28 that radiates transmitted waves towards a target object, a reception antenna 34 that catches and receives reflected waves from a target object (i.e., the reception waves 32 that is mainly the transmitted wave 30 which is reflected by the target object), a mixer 36 that generates a beat frequency signal through mixing of a reception signal and a transmission signal distributed by the directional coupler 26, a low-pass filter (LPF) that removes harmonic noise, and an analog/digital (A/D) converter 40 that converts an analog signal to a digital signal, for signal processing, have all the same configuration as in FM-CW radars of related technologies. The transmitting antenna 28 and the reception antenna 34 are linearly polarized, antennas oblique by 45°. The operation of the foregoing will be explained below with reference to FIG. 3.

A control unit 50 has the functions of processing a digital signal from the AM converter 40, determining the presence or absence of a target object, determining whether the target object is a on-road obstacle 12 if a target object is present, and issuing an appropriate detection output such as an alarm.

The control unit 50 has a primary determination module 52 that determines the presence or absence of a target object on the basis of an FM-CW radar function. The control unit 50 has also a secondary determination module 54 that acquires reception power of a reception wave, at a control period determined beforehand, when the primary determination module 52 determines that a target object is present; compares a time series change pattern, resulting from arranging the reception power of a reception wave in time series, versus a threshold value range pattern set beforehand on the basis of wave phase interference that depends on the height of the target object from the road, and determines whether the time series change pattern falls or not within the threshold value range pattern. The obstacle detection device 20 has a detection output device that, when the secondary determination module 54 determines that the time series change pattern is within a threshold value range, determines the target object to be an on-road obstacle 12 and outputs the result of this determination.

The above functions can be implemented by software, specifically through execution of a corresponding obstacle detection program. Some of the above functions may also be implemented by hardware.

A temporary storage memory 60 connected to the control unit 50 has the functions of acquiring the above-described reception power of reception waves at a control period determined beforehand, and temporarily storing the acquired reception, power in the form of reception power time series data 62 arranged in a time series.

A storage unit 70 connected to the control unit 50 has the functions of storing a program that is executed in the control unit 50, and also storing detected number-of-peaks threshold value range data 72 and detected peak value threshold value range data 74, as the threshold value range pattern that is used by the secondary determination module 54.

The control unit 50, the temporary storage memory 60 and the storage unit 70 can be configured in the form of a control device suitable for signal processing, for instance a suitable on-board computer. As described below, the primary determination module 52 has a Fourier frequency analysis function, and hence can be provided, as the case may require, with a fast Fourier transform device (FFT device) or the like separate from the computer having the signal processing function. The foregoing can make up collectively the control unit 50.

The functions of the primary determination module 52 and the secondary determination module 54 are explained in detail next with reference to FIGS. 3 to 6.

FIG. 3 is a diagram for illustrating the function of the primary determination module 52. The diagram maps the change of transmission and reception signals over time and a beat frequency signal, in the ordinate axis, with respect to time in the abscissa axis. The upper half of the diagram shows a frequency fₜ(t) of a wave transmitted from the transmitting antenna 28, and a frequency fᵣ(t) of a reception wave received by the reception antenna 34.

As explained in FIG. 1, the frequency of the oscillator 24 is modulated by the modulator 22. Herein, frequency is modulated in triangular waves, and hence the frequency fᵣ(t) of the transmitted wave and the frequency fₜ(t) of the reception wave change periodically, in the form of triangular waves, around the oscillation frequency f₀ of the oscillator 24. In the figure, T denotes the frequency modulation (FM) period, β denotes the FM width, and τ denotes the time delay between the transmitted wave and the reception wave.

The lower half of FIG. 3 illustrates the output waveform of a LPF 38. The output waveform appears as a beat frequency signal that is a composite wave generated through mixing of the transmitted wave and the reception wave by the mixer 36. Thus, the beat frequency signal exhibits a beat waveform wherein, due to the Doppler effect, two frequencies, namely frequencies f₀ and frequency f_{b}, are repeated over T, which is the FM period: The frequencies fₐ and f_{b} are given by the equations below as is commonly used, wherein R is the distance from the obstacle detection device 20 to the target object, V is the relative speed of the target object with respect to the obstacle detection device 20, and c is the speed of light.

fₐ=(4β/Tc)R+(2f₀/c)V

f_{b}=(4β/Tc)R−(2f₀/c)V

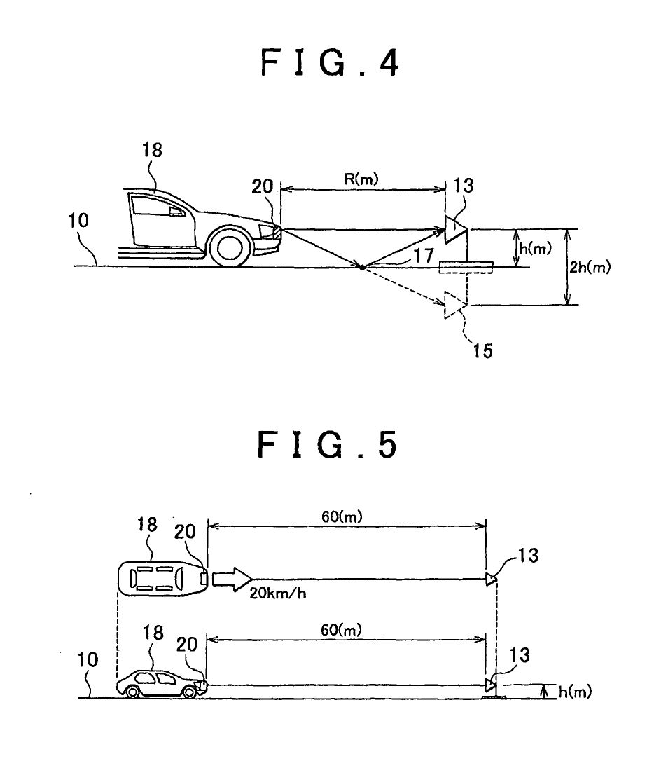

Therefore, R and V can be grasped by obtaining fₐ and f_{b} using an appropriate Fourier frequency analysis means such as FFT or the like. The distance to the target object and the relative speed of the target object can be detected using thus an FM-CW radar, and the presence or absence of the target object can be detected thereby. Thus far, only the mere presence or absence of the target object has been determined, Therefore, the target object thus determined might be an on-road obstacle 12, but also an in-air target object 14 or a road-surface target object 16. Accordingly, the function of the secondary determination module 54 will be explained next with reference to FIGS. 4 to 6.

FIG. 4 is a diagram for explaining envisaged environment conditions of the obstacle detection device 20. When a target object 13 is present, conceivable instances include direct detection of the target object 13, independently from the road 10, and detection of the target object 13 under the influence of reflection from the road 10. When the height of the target object 13 is sufficiently higher than the height of the vehicle 18, the target object corresponds to an in-air target object 14; when the height is close to zero, the target object corresponds to a road-surface target object 16; and when the height stands at about the height of the obstacle detection device 20, the target object corresponds to an on-road obstacle 12. If the magnitude of the height is not contemplated, the target object is deemed to be an ordinary target object 13.

Reflection occurs halfway between the obstacle detection device 20 and the target object 13. Therefore, reflection that occurs at the exact midpoint position between the obstacle detection device 20 and the target object 13 is thought to exert the greatest influence on detection of the target object 13. In FIG. 4, therefore, reflection is assumed to occur at an R/2 position 17 in the road 10, wherein R denotes the distance from the obstacle detection device 20 to the tar_{g}et object 13. A mirror image 15 of the target object 13 with respect to the road 10 is formed at a site ahead of the obstacle detection device 20 by a stretch R/2, in a straight line, from the R/2 position 17 on the road 10, in such a manner that, apparently, a wave advancing in a straight line from the obstacle detection device 20 towards the R/2 position 17 in the road 10 is reflected back, virtually, by the mirror image 15.

Thus, the wave transmitted by the obstacle detection device 20 can be reflected by the target object 13 and return along the following four paths.

A first path involves a single reflection wherein a wave from the obstacle detection device 20 strikes directly the target object 13 and returns directly to the obstacle detection device 20. With reference to FIG. 4, the first path is a path along obstacle detection device 20—target object 13—obstacle detection device 20.

A second path involves two reflections wherein a wave from the obstacle detection device 20 strikes directly the target object 13 and is reflected, strikes then the road 10, and returns to the obstacle detection device 20. With reference to FIG. 4, the second path is a path along obstacle detection device 20—target object 13—reflection position 17 on the road 10—obstacle detection device 20.

A third path involves two reflections wherein a wave from the obstacle detection device 20 strikes the road and strikes then the target object 13, is reflected, and returns, directly to the obstacle detection device 20. With reference to FIG. 4, the third path is a path from the obstacle detection device 20—reflection position 17 on the road 10—target object 13—obstacle detection device 20.

A fourth path involves three reflections wherein a wave from the obstacle detection device 20 strikes the road, strikes then the target object 13, is reflected, strikes again the road, and returns to the obstacle detection device 20. With reference to FIG. 4, the fourth pith is a path along the obstacle detection device 20—reflection position 17 on the road 10—target object 13—reflection position 17 on the road 10—obstacle detection device 20. Depending on the viewpoint, this latter path can be considered as identical to a path along obstacle detection device 20—mirror image 15 obstacle detection device 20.

The received power, i.e. reception power, is cut by cross polarization discrimination in the second path and the third path from among the above four paths, since the plane of polarization of the reception wave is orthogonal to the plane of polarization of the reception antenna 34 in the second path and the third path. Therefore, the second and the third paths can be overlooked in terms of received power,

Accordingly, only received power from the first path and from the fourth path need be considered.

The received power, i.e. reception power along the first path, is given by equation (1) and equation (2).

$$\begin{matrix}[ Equation 1 ] & \\ {P}_{r 1} = \frac{Pt \cdot {G}^{2} \cdot {λ}^{2} \cdot σ}{{( 4 π )}^{3} \cdot {R}^{4}} & ( 1 ) \\ [ Equation 2 ] & \\ {S}_{r 1} = {P}_{r 1} \cdot cos ( 2 π {f}_{1} t ) & ( 2 )\end{matrix}$$

In the equations, Pᵣ₁ is the received power in the first path, Pₜ is the transmission power, G is the transmission-reception gain, λ is the wavelength, σ is the radar cross section (RCS), and R is the above-described distance to the target object. Further, Sᵣ₁ is a received power signal that denotes the change of received power over time in the first path, and f₁ is the beat frequency in the first path. As described above, the beat frequency is defined by the distance R to the target object, the relative speed V of the target object and a point of time t.

The received power, i.e. reception power along the fourth path, is given by equation (3), equation (4) and equation (5).

$$\begin{matrix}[ Equation 3 ] & \\ {P}_{r 2} = A \cdot \frac{Pt \cdot {G}^{2} \cdot {λ}^{2} \cdot σ}{{( 4 π )}^{3} \cdot {( \sqrt{{R}^{2} + {( 2 h )}^{2}} )}^{4}} & ( 3 ) \\ [ Equation 4 ] & \\ {S}_{r 2} = {P}_{r 2} \cdot cos ( 2 π {f}_{2} t - φ ) & ( 4 )\end{matrix}$$

In the equations, Pᵣ₂ is the received power in the fourth path, Pₜ is the transmission power, A is a road surface reflection coefficient, G is the transmission-reception gain, λ is the wavelength, a is the RCS, R is the distance to the target object, and h is the height of the target object from the road 10. An instance has been envisaged herein where the radar and the target object have the same height, but the height of the foregoing may be dissimilar, without any problems. In the equations, Sᵣ₂ is a received power signal that denotes the change of received power over time in the fourth path, f₂ is a heat frequency in the fourth path, φ is the phase difference between the first path, which is a direct reflection path, and the fourth path, which is a road surface reflection path, and c is the millimeter wave propagation speed. As described above, the beat frequency is defined by the distance to the target object, the relative speed of the target object and a point of time t. Herein, the target object is considered to be the apparent mirror image 15.

Phase interference of received power signal between the first path and the fourth path can be expressed by equation (6), by combining equation (2) and equation (4):

[Equation 6]

S=Sᵣ₁+Sᵣ₂=Pᵣ₁·cos(2πf₁t)+Pᵣ₂·cos(2πf₂t−φ) (6)

Examples of calculations based on the above equations are given below. The situation illustrated in FIG. 5 was used as the calculation model. FIG. 5 is a diagram for explaining a situation wherein the vehicle 18 approaches a stationary target object 13. The parameters of the model included a speed of 20 km/h of the vehicle 18, a distance R=60 in from the obstacle detection device 20 to the target object 13, and a height h of the target object 13 from the road 10. As described above, when h is sufficiently higher than the height of the vehicle, h corresponds to an in-air target object 14, and when h is near zero, h corresponds to a road-surface target object 16.

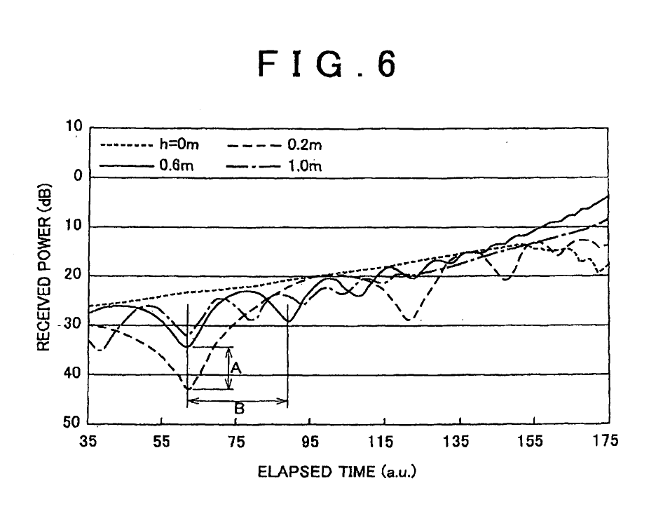

FIG. 6 is a diagram illustrating the calculation results, based on Equation (6), of the change of a received power signal over time upon changes in the height h of the target object 13 from the road 10. The abscissa axis represents time and the ordinate axis represents the magnitude of received power. Both the abscissa axis and the ordinate axis have been appropriately normalized. The time in the abscissa axis corresponds to changes in the distance between the obstacle detection device 20 and the target object 13, which becomes gradually shorter from 60 m as the vehicle 18 travels towards the target object 13 in the model of FIG. 5.

In FIG. 6, the height h of the target object 13 from the road 10 changes from 0 m, to 0.2 m, 0.6 m and 1.0 m. Herein, h=0 m is the road face, and corresponds to an instance of a road-surface target object 16, for example an iron plate laid on the road 10. The height h=0.6 m is assumed to be the height, from the road 10, at which the obstacle detection device is installed in the vehicle. A target object 13 at this height should be detected as an on-road obstacle 12 by the obstacle detection device 20. Heights of h=0.2 m and h=1.0 m are envisaged to be limiting heights between which the target object should be detected as an on-road obstacle 12, taking into account the directionality of the FM-CW radar from h=0.6 m.

In FIG. 6, the received power time series data exhibits time series change patterns that are dissimilar depending on the height of the target object from the road. Except for h=0 m, the time series change pattern of the received power time series data exhibits periodic peaks at which received power is attenuated and drops, as illustrated in FIG. 6. Each of these peaks at which received power decreases are called decrease-side peaks of reception power, such that a decrease-side peak of reception power, in time series change data of reception power, is a convex minimum, at a reception power decrease side, having a characteristic whereby reception power decreases over time down to a minimum, and increases again, over time, from the minimum.

In the above time series change pattern, the decrease-side peak of reception power is based on phase interference between waves (reception waves) according to Equation (6). In particular, power is attenuated due to the mutually opposite phases of the received power signal in the first path and the received power signal in the fourth path. The results of FIG. 6 show thus that wave phase interference, in particular power attenuation, changes depending on the height of the target object 13 from the road 10.

For instance, in the time series change patterns for h=0.2 m, 0.6 m, 1.0 m, the decrease-side peak of reception power, being a peak at which received power decreases, is repeated periodically. By contrast, there is virtually no peak at which the received power decreases for the time series change pattern of h=0 m. This indicates that the time series change pattern exhibits no decrease-side peak of reception power when there is a road-surface target object 16. In other words, a decrease-side peak of reception power is observed when there is an on-road obstacle 12. Accordingly, whether or not the target object 13 is an on-road obstacle 12 can be determined on the basis of the presence or absence of a decrease-side peak of reception power.

In FIG. 6, the absolute value of the size A of a decrease-side peak of reception power that exhibits power attenuation (maximum reduction width of the time series change pattern) increases as the height h of the target object, which is an on-road obstacle becomes smaller (lower). It is considered this is because the beat frequency in the first path and the beat frequency in the fourth path come closer to each other, and radio wave interference increases accordingly, as h becomes smaller. The maximum reduction width is the length between a decrease-side peak (minimum) of interest and a point of intersection of a straight line that joins maxima before and after the minimum and a line of a given lapse of time that passes through the minimum.

In FIG. 6, a period B of the decrease-side peak of reception power becomes shorter as the height h of the target object, which is an on-road obstacle, becomes higher. It is considered this is because phase rotation accelerates in accordance with a greater difference between the propagation path length along the first path and the propagation path length along the fourth path.

The results from FIG. 6 show that it is possible to compare a time series change pattern of reception power time series data versus a threshold value range pattern which is set beforehand, on the basis of wave phase interference that depends on the height of the target object from the road, and to determine whether the time series change pattern falls within the threshold value range pattern. The secondary determination module 54 of the control unit 50 has the function of performing such a determination.

As the threshold value range pattern there can be used a time series change pattern of the reception power time series data at a time when the height h of the target object 13 from the road 10 is identical to the height of the obstacle detection device 20. This threshold value range pattern can be defined by the relative speed V of the target object 13 with respect to vehicle 18, and by the distance R between the vehicle 18 and the target object 13. More simply, however, the relative speed V and the distance R can be defined beforehand as a standard state, and there can be used a standard threshold value range pattern, which is a time series change pattern of reception power time series data at that standard state. For instance, V=20 km/h and R=60 m in the model of FIG. 5 can be defined as the standard state. In this case, the time series change pattern of the received power time series data of the solid line in FIG. 6 constitutes the threshold value range pattern.

Criteria based on the threshold value range pattern can be established as follows. (1) The height of the target object 13 is lower than the height of the obstacle detection device if the decrease-side peak of reception power, i.e. power attenuation, is attenuated more than in the case of the threshold value pattern. (2) The height of the target object 13 is higher than the height of the obstacle detection device if the power attenuation is an attenuation amount smaller than that of the threshold value pattern. (3) The height of the target object 13 is substantially the same as the height of the obstacle detection device if the power attenuation is substantially identical to that of the threshold value pattern.

(4) The height of the target object 13 is lower than the height of the obstacle detection device if the period of the decrease-side peak of reception power, being a phase interference period, is longer than the period of the threshold value pattern. (5) The height of the target object 13 is higher than the height of the obstacle detection device if the phase interference period is shorter than the period of the threshold value pattern. (6) The height of the target object 13 is substantially the same as the height of the obstacle detection device if the phase interference period is substantially the same as the period of the threshold value pattern.

A decision time can be determined beforehand, such that the above decisions are made by carrying out the above-described comparisons, at that decision time. The decision time is set in such a manner so as to be over with sufficient margin for allowing the vehicle 18 to avoid, for instance, collision against the on-road obstacle 12, through braking or avoidance,

In the above-described determination based on the phase interference period, there can be detected the number of decrease-side peaks (i.e., minimum points) of reception power within the decision time, and the detected number of peaks can be used instead of the period. Specifically, the threshold value pattern of phase interference period can be used as the threshold value pattern of the detected number of peaks, through conversion to the detected number of peaks within the decision time. The number of minimum points, maximum points, decrease-side inflection points, or increase-side inflection points can be used instead of the period. The combination of at least two of the number of the minimum points, the number of the maximum points, the number of the decrease-side, inflection points, and the number of the increase-side inflection points may be used. The decrease-side inflection point of reception power is an inflection point of reception power while reception power decreases with time, in the time series change data on reception power. The increase-side inflection point of reception power is an inflection point of reception power while reception power increases with time, in the time series change data on reception power.

In the above decisions, the target object can be considered not to be an on-road obstacle 12 if, for instance, the deviation of power attenuation from the threshold value range pattern is equal to or greater than 15 dB in (1), (2). For instance, the target object can be considered not to be an on-road obstacle 12 if the deviation of the detected number of peaks or the phase interference period from the threshold value pattern in (3), (4) is equal to or greater than 20%. Needless to say, the above decision criteria can be appropriately modified in accordance with, for instance, the specifications of the vehicle 18.

As already explained regarding FIG. 6, it can be determined that the height h of the target object 13 is 0 m when the obtained reflected waves give rise to no phase interference at all, and there is detected no decrease-side peak of reception power in the time series-change pattern of the reception power time series data. That is, the target object 13 can be considered to be a road-surface target object 16, and not an on-road obstacle 12, even if the primary determination module 52 determines that a target object 13 is present.

In the above decisions, an appropriate output such as an alarm or the like is issued when it is determined that the target object 13 is an on-road obstacle 12. Upon receiving the alarm, the user can safely stop the vehicle 18 or cause the latter to drive the vehicle 18 to avoid the on-road obstacle 12. The function of the preventive safety system, such as an alarm output or the like, can be turned off, regardless of the determination results by the primary determination module 52, in case that in the above decisions the target object 13 is not considered to be an on-road obstacle 12. This allows reducing the occurrence of erroneous or unnecessary operations by the preventive safety system.

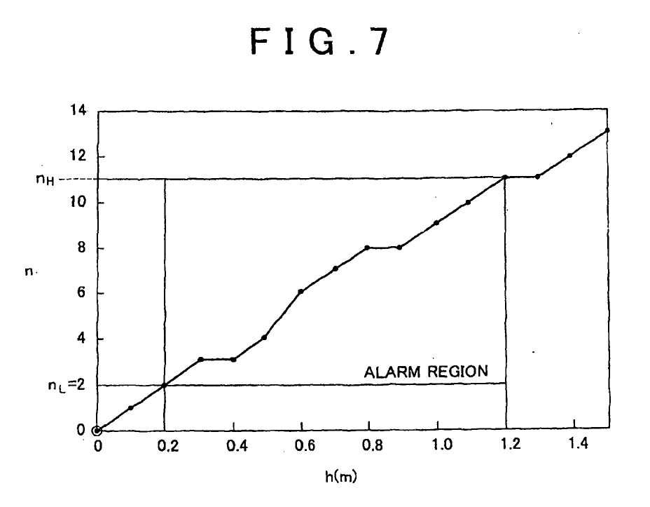

FIG. 7 is a diagram illustrating, by way of example, the setting of a threshold value range pattern for alarm output in a case where it is to be determined whether or not a target object is an on-road obstacle according to a phase interference period. FIG. 7 is a diagram illustrating a relationship between the height h of a target object, in the abscissa axis, and the detected number of peaks n within a decision span, in the ordinate axis. FIG. 7 illustrates a working example of a specific calculation performed on a different example from that explained in FIG. 6.

In the example of FIG. 7, n tends to increase from zero to 13 substantially linearly, within a range of h from zero to 1.5 m. As the threshold value range there can be set, thus, the range of the number of detected peaks n corresponding to a range of height h defined as the range, centered around the height of obstacle detection device 20 from the road 10, within which the obstacle detection device 20 should detect the on-road obstacle 12. The obstacle detection device 20 is, for example, mounted on the vehicle. In the example of FIG. 7, h=0.2 m is set as the lower limit for distinguishing a road-surface target object 16, and h=1.2 m is set as the upper limit for distinguishing an in-air target object 14. Thereby, the lower limit of the detected number of peaks becomes n_{L}=2 and the upper limit n_{H}=11. Accordingly, a range from 2 to 11 is set as the threshold value setting range of the detected number of peaks n.

An alarm can be outputted, to notify that the target object 13 is an on-road obstacle 12, if the actual detected number of peaks falls within the threshold value range. In the example of FIG. 7, therefore, the range of h from 0.2 m to 1.2 m, or the range of n from 2 to 11, constitutes an alarm region.

When n=0, as described above, it is obvious that the target object is not an on-road obstacle 12. Therefore, the alarm issuing function itself is turned off. Erroneous alarm operations can be suppressed thereby.

The threshold value range pattern illustrated in FIG. 7 is stored in the detected number-of-peaks threshold value range data 72 of the storage unit 70. Similarly, the threshold value range pattern for the detected peak value of the decrease-side peak, which is the power attenuation amount, is stored in the detected peak value threshold value range data 74.

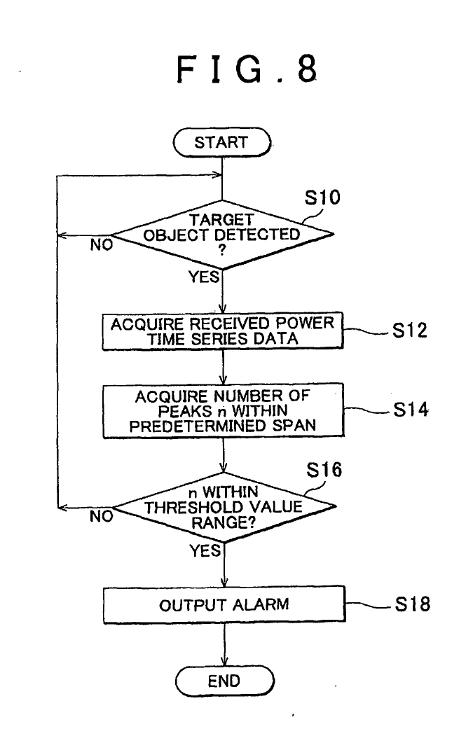

The operation of the obstacle detection device 20 having the above configuration will be explained next with reference to the flowchart of FIG. 8. FIG. 8 is a flowchart illustrating an obstacle detection sequence. Each step in the sequence corresponds to a respective processing step in an obstacle detection program. An explanation follows next on an instance where the detected number of peaks is used as the determination criterion in the secondary determination module 54, but obstacle detection can be carried out according to identical steps also when using detected peak value as the determination criterion.

With the vehicle 18 running, an obstacle detection program is launched, and a preventive safety system function set beforehand is turned on. The FM-CW radar transmits waves from the obstacle detection device 20 ahead of the vehicle 18, to detect the presence or absence of a target object. It is then determined whether the presence of a target object has been detected or not (S10). This function is executed on the basis of the function of the primary determination module 52 of the control unit 50. Specifically, a target object 13 ahead of the vehicle 18 is determined to be present through detection of the distance R of the target object 13, and the relative speed V of the target object 13, according to the principle of the FM-CW radar explained in FIG. 3.

A received power time series data is acquired when the determination in S10 is affirmative (S12). Specifically, the primary determination module 52 obtains and acquires received power, i.e. reception power at that time, on the basis of the power spectrum used during frequency analysis for obtaining the beat frequency. The primary determination module 52 performs this acquisition at each process timing at which the presence or absence of a target object is determined. The primary determination module 52 associates the acquired received power data, at each processing timing, with the time of acquisition, and stores the power data associated with the time of acquisition in the temporary storage memory 60. The content of the received power time series data is as explained in FIG. 6.

Next, the number of decrease-side peaks n in the received power time series data within the decision span, which is a predetermined span determined beforehand, is worked out and is acquired next on the basis of the received power time series data (S14). In FIG. 6, for instance, the decision span is the entire abscissa axis and the acquired received power time series data is the data designated by a broken line in FIG. 6. In this case, the decrease-side peaks are three, and hence n=3 is acquired.

It is determined whether or not the acquired n falls within a threshold value range pattern determined beforehand (S16). The threshold value range pattern is stored in the detected number-of-peaks threshold value range data 72 of the storage unit 70. Therefore, determination can be carried out by reading the stored threshold value range pattern and comparing the latter with the acquired n. An example of the detected number-of-peaks threshold value range data is explained in FIG. 7. When n=3, which falls within the range between n_{L} and n_{H} in FIG. 7, the process moves onto S18, and an alarm is outputted. Other than an alarm output, there may be issued an appropriate output that notifies the user of the target object 13 being an on-road obstacle 12. For instance, there may be outputted a control signal for automatically triggering braking or the like.

When in S10 or S16 the determination is negative, the process returns to S10. The process from S12 to S16 is executed based on the function of the secondary determination module 54 of the control unit 50. The process of S18 is executed based on the function of the detection output module 56.

It is thus possible to determine appropriately whether or not a target object is an on-road obstacle, by supplementing FM-CW radar technology with execution of signal processing for determining the degree of phase interference.

The obstacle detection device according to the invention can be used as a device for obstacle detection installed in a moving object such a vehicle, and can be used also as a fixed installation-type obstacle detection device for detecting a moving object.

1. An obstacle detection device, comprising:
a primary determination device that transmits a wave, receives a reception wave from a target object, that is a reflection wave of the wave reflected on the target object, and determines the presence or absence of the target object on the basis of a comparison between the transmitted wave and the reception wave;
a first storage device that, when the primary determination device determines that the target object is present, acquires a reception power of the reception wave in a control cycle determined beforehand, and stores the acquired reception power as reception power time series data in time series;
a second storage device that stores a predetermined threshold value range pattern set beforehand on the basis of phase interference of the reception wave that depends on a height of the target object from a road so as to distinguish the target object from an on-road obstacle, a road-surface target object or an in-air target object using a height of the primary determination device from the road as a reference height;
a secondary determination device that compares a time series change pattern of the reception power time series data a with the predetermined value range pattern, and determines whether the number of local minimum points in the time series change pattern of the reception power time series data falls within a range within which the obstacle detection device determines the target object to be the on-road obstacle;
a detection output device that determines the target object to be the on-road obstacle when the second determination device determines that the number of local minimum points in the time series change pattern falls within the range within which the obstacle detection device determines the target object as the on-road obstacle, and outputs a result of this determination.

2. An obstacle detection device, comprising:
a primary determination device that transmits a wave, receives a reception wave from a target object that is a reflection wave of the wave reflected on the target object, and determines the presence or absence of the target object on the basis of a comparison between the transmitted wave and the reception wave;
a first storage device that, when the primary determination device determines that the target object is present, acquires a reception power of the reception wave in a control cycle determined beforehand, and stores the acquired reception power as reception power time series data in time series; a second storage device that stores a predetermined threshold value range pattern set beforehand on the basis of phase interference of the reception wave that depends on a height of the target object from a road so as to distinguish the target object from an on-road obstacle, a road-surface target object or an in-air target object using a height of the primary determination device from the road as a reference height;
a secondary determination device that compares a time series change pattern of the reception power time series data with the predetermined value range pattern, and determines whether a maximum reduction width of the time series change pattern of the reception power time series data falls within a range within which the obstacle detection device determines the target object to be the on-road obstacle;
a detection output device that determines the target object to be an the on-road obstacle when the secondary determination device determines that
the maximum reduction width of the time series change pattern falls within the range within which the obstacle detection device determines the target object as the on-road obstacle, and outputs a result of this determination.

3. The obstacle detection device according to claim 1, wherein the detection output device determines the target object not to be the on-road obstacle if the deviation of the number of local minimum points from the threshold value pattern is equal to or greater than 20%.

4. The obstacle detection device according to claim 1, wherein the detection output device determines the target object not to be the on-road obstacle and does not issue an alarm, if the number of local minimum points in the time series change pattern of the reception power time series is 0.

5. (canceled)

6. The obstacle detection device according to claim 1, wherein the primary determination device determines the presence or absence of the target object using an FM-CW radar.

7. The obstacle detection device according to claim 2, wherein the detection output device determines the target object not to be the on-road obstacle if the deviation of the number of local minimum points from the threshold value pattern is equal to or greater than 20%.

8. The obstacle detection device according to claim 2, wherein the detection output device determines the target object not to be the on-road obstacle and does not issue an alarm, if the number of local minimum points in the time series change pattern of the reception power time series is 0.

9. The obstacle detection device according to claim 2, wherein the primary determination device determines the presence or absence of the target object using an FM-CW radar.
